(19) United States
(12) Patent Application Publication
(10) Pub. No.: US 2009/0041048 A1
(43) Pub. Date: Feb. 12, 2009

(54) SYSTEM AND METHOD FOR PERSONAL LIVE TELEVISION

(76) Inventor: Paul Borrel, Cortlandt Manor, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/834,174

(22) Filed: Aug. 6, 2007

(51) Int. Cl. H04L 12/28

(52) U.S. Cl. 370/419

(57) ABSTRACT

A system comprising a receiver and a transmitter for sending and receiving audio-video datastreams through fixed IP addresses, which IP addresses are established upon initialization of the transmitter and receiver systems. The transmitter includes an audio-visual capture and encoding subsystems, and the receiver includes an audio-visual decoding and display subsystems.

### BACKGROUND OF THE INVENTION

1. Field of the Invention

The present invention generally relates to the sending and receiving of live video using the Internet.

2. Background Description

There are multiple sources of live video available on the Internet today. Web cams, for example, can easily be set up to facilitate live video and audio collaborations through a range of widely available software such as, to give but one example, MSN (Windows Live Messenger). Open source software can be used to broadcast live videos on the Internet, which can be read by a client computer that connects to the appropriate IP address. Some web sites broadcast live video feeds on a permanent basis, such as a NASA web site broadcasting live video views from the International Space Station. Broadcasting and receiving such live videos requires the use of computers at both ends to access the Internet in order to stream the video in and out, since computers are used both as transmitters and as receivers.

The present art requires a series of computer applications to send and receive live video over the Internet. Receiving live video, for example, requires an application that specifies, explicitly or implicitly, the IP address of the emitting site for streaming in and decoding the video signal. Because the present art can accomplish the sending and receiving of live video over the Internet only through a series of computer applications, it is necessary to have fully functional computers at both the transmitting and receiving ends of a live video communication.

### SUMMARY OF THE INVENTION

It is the object of the present invention to enable live video to be sent and received over the Internet without the need to have fully functional computers at both ends of the transmission. The present invention allows for functions and procedures that use the Internet to transmit and receive live video without users being aware that computer hardware and software is involved, thereby greatly simplifying the set up and use of the video communication. In effect, the invention permits the implementation of live video television by connecting a predetermined source of live video content to a receiver to enable a viewer to watch the video.

The present invention comprises a receiver and a transmitter, plus the applications that use them. The receiver consists of a simple display that is able to connect to one or more predetermined IP addresses, receive video streams, and display live video being broadcast from the IP address(es). The transmitter is a simple video camera that is able to broadcast a live video to a predetermined IP address.

The ease-of-setup and ease-of-use of equipment provided according to the present invention can be expected to create opportunities for entirely new applications of live Internet video, including, without limitation, the following:
Live Frame. “Live Frame” is a picture frame that has a single power cord. When plugged in, the frame automatically (1) establishes an Internet connection to a fixed IP address through, for example, wireless telephone or local Wi-Fi connection and (2) streams in and displays live images of a predetermined site. The predetermined site may be any site of which users seek to have a live view in their homes on a “24/7” (24 hours a day, seven days a week) basis. The predetermined site may be, by way of example and not limitation, a famous tourist attraction such as the Eiffel Tower, Time Square, the Taj Mahal, the Bay of Naples, and so forth. The predetermined site may also be an individually selected view such as, by way of example and not limitation, a family property, a view of a home village, a view into grandchildren's playroom, and so forth.
Corporate video link conference rooms. In large, worldwide, distributed enterprises (including, but not limited to, IBM), meetings are often conducted through telephone conferences between participants located at different sites around the world. Video telecommunication exists, but video teleconferences are seldom used. This is in large part because the relatively high cost of making video teleconference rooms ready for use reduces the availability of video teleconference rooms. The present invention, however, can make it possible for each conference room (or even each office) of every site to be equipped with both a receiving display and a broadcasting camera, as described above. Videoconference participants would simply choose which videoconference room to connect to for the conference.
   Depending on the scenario, a wide range of different business models can be used to manage the usage of the equipment (e.g., a fixed rate, a used-based rate, and so forth).

The present invention thus provides a system and a method for personal live television comprising: a transmitter system comprising a capture system that captures audio and visual data and sends the audio-visual data to a datastream transmitter which encodes the audio-visual data into a datastream format and sends an audio-visual datastream via a transmitting Internet connection subsystem to a preset IP address on the Internet; and a receiver system comprising a receiving Internet connection subsystem that obtains an audio-visual datastream from a preset IP address on the Internet and sends the datastream to a datastream receiver which decodes audio and visual data contained in the datastream and delivers the audio and visual data to an audio-visual display apparatus. Preset IP addresses for transmitting and receiving audio-visual datastreams are established upon initialization of the transmitter system and receiver system. The transmitting and/or receiving Internet connection subsystems may establish an Internet connection via any of the following: a wireless network; a local area network; a high-speed broadband network; a cellular telephone network; or any other manner of establishing an Internet connection.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows Corporate Video Link Conference Rooms according to the present invention.

FIG. 2 shows a Live Frame according to the present invention.

FIG. 3 shows a schematic of a transmitter system and a receiver system according to the present invention.

### DETAILED DESCRIPTION OF A PREFERRED EMBODIMENT OF THE INVENTION

In the preferred embodiment of the present invention, a transmitter and a receiver are purpose-built to provide audio and video linkage functionality through predetermined IP addresses. The receiver and transmitter are thus, in effect, “pre-programmed” to connect to each other. The preset IP addresses are established upon initialization or powering-up of the transmitter and the receiver by an IP address controller that identifies the transmitter and receiver from their unique identifier. The subsystems that comprise the receiver and the transmitter would thus seek to establish a video link through the predetermined IP addresses. The transmitter would, upon being powered up and connected to the Internet, begin to capture live audio and video (sound and images) of the surroundings of its camera and stream the audio and video to the predetermined IP address. Meanwhile, the receiver, upon being powered up and connected to the Internet, would await streaming audio and video directed to it through the predetermined IP address, display streamed video on a screen and playing streamed audio through a speaker.

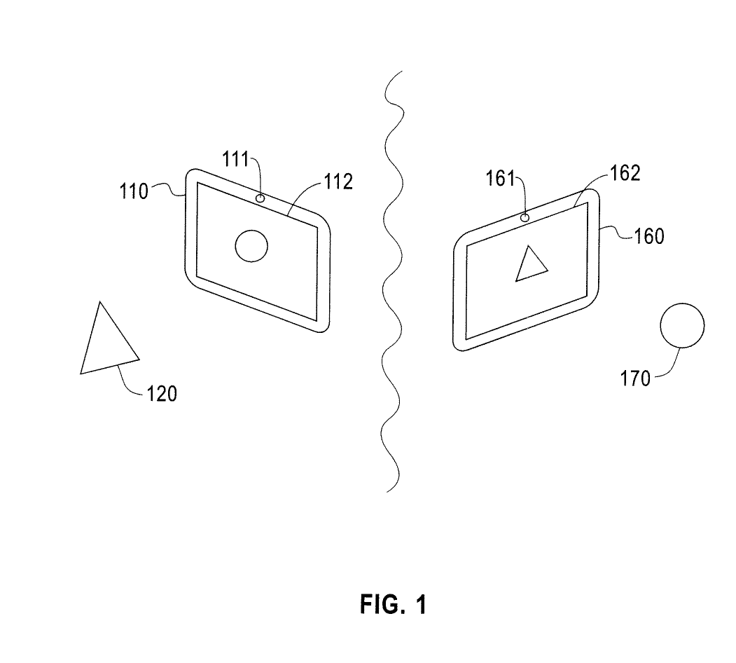

Referring now to the drawings, and more particularly to FIG. 1, there is shown a transmitter-receiver 110 in a first location on which is included a camera 111 and a display screen 112, plus a transmitter-receiver 160 in a second location on which is included a camera 161 and a display screen 162. The display screen 112 on the transmitter-receiver 110 in the first location presents the scene 170 within view of the camera 161 in the second location, while the transmitter-receiver 160 in the second location presents the scene 120 within view of the camera 111 in the first location. The scene 120 in the first location and the scene 170 in the second location may be views of the interiors of video conference rooms, as would be used for Corporate Video Link Conference Rooms.

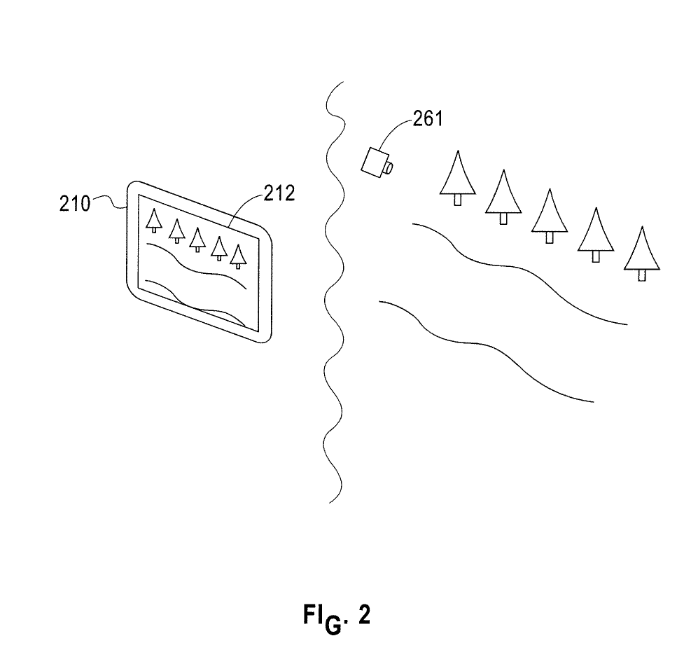

According to FIG. 2, there is shown a receive-only unit 210 on which is included a display 212 showing a Live Frame scene as viewed by a camera 261 in a remote location.

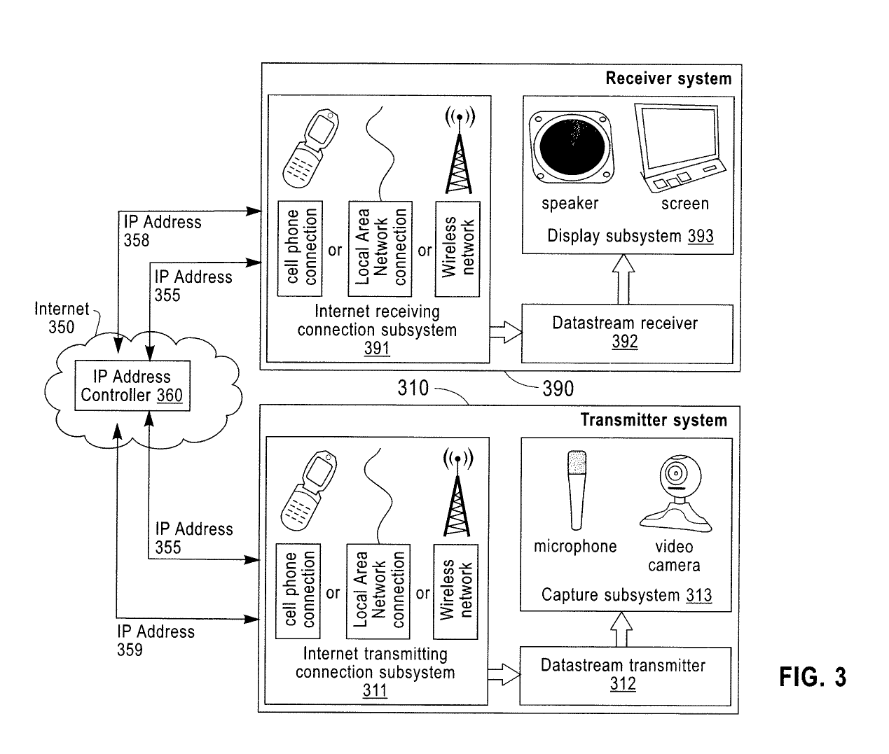

According to FIG. 3, there is shown a transmitter system 310 and a receiver system 390 connected to each other via the Internet 350 and an IP address controller that communicates with the receiver and transmitter using IP addresses 358 and 359.

In the transmitter system 310, an Internet connection subsystem 311 establishes a connection to the Internet 350. The subsystem may enable the connection to be established in one or more of several different ways, including, but not limited to, a local wired or wireless network connection, a high-speed wireless broadband network, a cell phone connection, or any other way of providing an Internet connection with sufficient bandwidth to accommodate uploading a live video stream from the transmitter to the Internet. A capture subsystem 313 includes video camera and microphone functionalities, which may be integrated into a single device or provided by separate devices connected to form a single subsystem. A streaming subsystem 312 receives input from the capture subsystem, encodes the input into an audio-video datastream that is sent via the Internet connection subsystem 311 to predetermined IP address 359 on the Internet 350. The predetermined IP address 359 is obtained from an IP address controller 360 upon initialization of the transmitter system 310. Because the transmitter and receiver are special-purpose devices and not reprogrammable computers, the audio-video streaming subsystem may be built to employ either (i) closed architecture and/or closed data formats or (ii) industry standard architectures and/or industry standard data formats such as, for example, Microsoft's Windows Media Encoder and others.

The receiver system 390 includes a streaming subsystem 392 which receives, via the connection established by the Internet connection subsystem 391, an audio-video stream from predetermined IP address 358. The predetermined IP address 358 is obtained from an IP address controller 360 upon initialization of the receiver system 390. A display subsystem 393 includes display screen (analogous to computer or television display screen) and speaker functionalities, which may be integrated into a single device or provided by separate devices connected to form a single subsystem. The streaming subsystem 392 decodes the audio-video stream into image and sound data compatible with the display subsystem 393 and sends it to the display subsystem for display.

Both the transmitter and the receiver own their respective unique identifier. When powered-up, they send this identifier to the IP controller 360 through a fixed predetermined IP address 355. The controller then establishes a connection with the transmitter and the receiver through the IP addresses 358 and 359.

A Live Frame implemented according to this embodiment of the present invention would have a transmitter system at one end and a receiver system at the other end. Multiple receiver systems could display the audio-visual data of a single transmitter system by initializing multiple receiver systems with the same preset IP address.

Corporate video-link conference rooms implemented according to this embodiment of the present invention would have, in each conference room, a device comprising a transmitter system and a receiver system. Using split-screen display formats, more than two video-link conference rooms could participate in single conference by initializing them all with the same preset IP address.

Having thus described our invention, what we claim as new and desire to secure by Letters Patent is as follows:

1. A system for personal live television comprising:
a transmitter system comprising a capture system that
captures audio and visual data,
sends said data to a datastream transmitter which encodes said data into a datastream, and
sends an audio-visual datastream via a transmitting Internet connection subsystem to a preset IP address on the Internet,
said preset IP address being obtained from an Internet connected IP address controller upon initialization of the transmitter system; and
a receiver system comprising a receiving Internet connection subsystem that
obtains an audio-visual datastream from a preset IP address on the Internet,
said preset IP address being obtained from an Internet-connected IP address controller upon initialization of the receiver system,
sends said datastream to a datastream receiver which decodes audio and visual data contained in the datastream, and
delivers said audio and visual data to an audio-visual display apparatus.

2. The system of claim 1, wherein the transmitting Internet connection subsystem establishes an Internet connection via a wireless network.

3. The system of claim 1, wherein the transmitting Internet connection subsystem establishes an Internet connection via a local area network.

4. The system of claim 1, wherein the transmitting Internet connection subsystem establishes an Internet connection via a high-speed broadband network.

5. The system of claim 1, wherein the transmitting Internet connection subsystem establishes an Internet connection via a cellular telephone network.

6. The system of claim 1, wherein the receiving Internet connection subsystem establishes an Internet connection via a wireless network.

7. The system of claim 1, wherein the receiving Internet connection subsystem establishes an Internet connection via a local area network.

8. The system of claim 1, wherein the receiving Internet connection subsystem establishes an Internet connection via a high-speed broadband network.

9. The system of claim 1, wherein the receiving Internet connection subsystem establishes an Internet connection via a cellular telephone network.

10. A method for personal live television comprising the steps of:
capturing audio and visual data and encoding said data into a datastream;
sending an audio-visual datastream via a transmitting Internet connection subsystem to a preset IP address on the Internet, said preset IP address being obtained from an Internet-connected IP address controller upon initialization of the transmitting Internet connection subsystem;
receiving, via a receiving Internet connection subsystem, an audio-visual datastream from a preset IP address on the Internet, said preset IP address being obtained from an Internet-connected IP address controller upon initialization of the receiving Internet connection subsystem; and
decoding said audio-visual datastream and displaying the audio and visual data contained in the datastream on an audio-visual display apparatus.
